(19) United States
(12) Patent Application Publication
(10) Pub. No.: US 2014/0197685 A1
(43) Pub. Date: Jul. 17, 2014

(54) TRANSMISSION STATION

(71) Applicant: ASKEY COMPUTER CORP., NEW TAIPEI CITY (TW)

(72) Inventors: Chau-Da Su, Hsinchu County (TW); Shih-Feng Lie, Taipei City (TW)

(73) Assignee: ASKEY COMPUTER CORP., NEW TAIPEI CITY (TW)

(21) Appl. No.: 14/023,478

(22) Filed: Sep. 11, 2013

(30) Foreign Application Priority Data
Jan. 15, 2013 (TW) 102101542

(51) Int. Cl. H02J 4/00

(52) U.S. Cl. CPC H02J 4/00
USPC 307/11

(57) ABSTRACT

A transmission station adapted to provide power to at least one network device and transmit signal to the network device is provided. The transmission station includes a housing, a network hub, and a power supply. The housing has a supporting surface, and the network device is disposed on the supporting surface. The network hub is disposed in the housing and transceives a number of transmission signals. The network hub includes a number of signal-transmitting ports to transmit and receive the transmission signals to each network device respectively. The power supply is disposed in the housing and produces multiple output power and operating power. The power supply provides the operating power to the network hub and the power supply includes a number of power-outputting ports to provide the output power to each network device respectively.

### CROSS-REFERENCE TO RELATED APPLICATION

This application claims the priority benefit of Taiwan application serial no. 102101542, filed on Jan. 15, 2013. The entirety of the above-mentioned patent application is hereby incorporated by reference herein and made a part of this specification.

### BACKGROUND

1. Field of the Invention

The present invention is directed to a transmission station and more particularly, to a transmission station capable of simultaneously outputting power and transmitting signals.

2. Description of Related Art

With increasingly development of technology nowadays, the Internet has become an indispensable tool for modern people. In order to be compliable with different specifications or many types of network connection, various types of network device, such as a wireless access point (wireless AP), and a femtocell AP have developed accordingly. However, when a user uses multiple network devices at the same time, each of the different network devices has to be connected with its power supply through a power line and then connected with its network hub through a network line. Thus, the user has to separately buy a power supply, a power line and a network line for each of the network devices so that the cost for the user spending on the network devices is increased. Moreover, for the user, too many power supplies are too space-consuming, and it is inconvenient to organize lots of network lines and power lines. Therefore, it is necessary to provide a more convenient integration method for the user to save troubles when using multiple network devices at the same time.

### SUMMARY

The present invention is directed to a transmission station integrating a power supply with a network hub.

The present invention is directed to a transmission station adapted to provide power to one or more network devices and transmit signals to the network devices. The transmission station includes a housing, a network hub and a power supply. The housing surrounds a containing space and has a supporting surface, and the network device is disposes on the supporting surface. The network hub is disposed in the housing and transceives a plurality of transmission signals. The network hub includes a plurality of signal-transmitting ports to transceives the transmission signals to each of the network devices, respectively. The power supply is disposed in the housing, produces a plurality of output power and a operating power and provides the operating power to the network hub. The power supply includes a plurality of power-outputting ports to provide the output power to each of the network devices, respectively.

In an embodiment of the present invention, the power supply further produces an expanded output power and the network hub further transceive an expanded transmission signal, such that the transmission station provides the expanded output power and transmits the expanded transmission signal to another transmission station.

In an embodiment of the present invention, the housing further includes a fastening structure, and the transmission station is adapted to be fastened with another transmission station through the fastening structure.

In an embodiment of the present invention, the transmission station further includes a circuit board and an expansion connector. The circuit board is disposed in the containing space, and the network hub and power supply are disposed on the circuit board. The expansion connector is disposed on a first side of the housing and coupled with the circuit board. The expansion connector receives the expanded output power provided by the power supply and the expanded transmission signal provided by the network hub.

In an embodiment of the present invention, the housing includes a plurality of connection openings located on a second side of the housing. The signal-transmitting ports and the power-outputting ports are exposed from the connection openings. Therein, the second side is different form the first side.

In an embodiment of the present invention, the network hub includes a plurality of network lines and each of the network lines passes through the corresponding connection opening to connect with the corresponding signal-transmitting port and the corresponding network device. The power supply includes a plurality of power lines, and each of the power lines passes through the corresponding connection opening to connect with the corresponding power-outputting port and the corresponding network device.

In an embodiment of the present invention, one end of each of the power lines is connected with the corresponding power-outputting port, and, and the other end of each of the power lines is connected with a power adaptor or a universal serial bus (USB) connector plug.

In an embodiment of the present invention, the housing includes a plurality of containing slots disposed at the second side of the housing, and each of the network lines and each of the power lines are retracted in the corresponding containing slot.

In an embodiment of the present invention, the housing a plurality of side covers pivoted to the housing and covering the corresponding containing slots. Each of the connection openings is disposed on the corresponding side cover.

In an embodiment of the present invention, the housing further includes a supporting portion contacting the supporting surface and at least one of the network devices leans against the supporting portion.

To sum up, the power supply of the transmission station of the present invention provides the operating power to the network hub and provides the output power to each of the network devices. Meanwhile, the power supply and the network hub are integrated in the transmission station, such that a user may use the transmission station to provide power and transceive signals to a plurality of network devices. Moreover, by integrating the power supply and the network hub integrated in the transmission station, an advantage of space saving may be achieved.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a block diagram illustrating a transmission station according to an embodiment of the present invention.

FIG. 2 is a schematic perspective diagram of implementing the transmission station depicted in FIG. 1 according to an embodiment of the present invention.

FIG. 3 is a schematic perspective diagram illustrating the transmission station depicted in FIG. 2 connected with another transmission station.

FIG. 4 is an exploded diagram of the transmission station depicted in FIG. 2.

### DESCRIPTION OF EMBODIMENTS

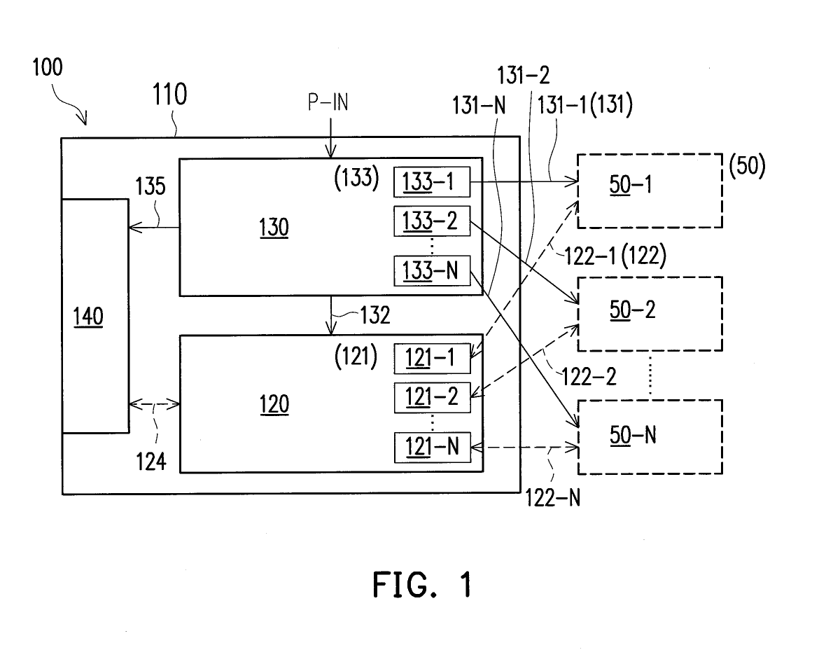

FIG. 1 is a block diagram illustrating a transmission station according to an embodiment of the present invention. Referring to FIG. 1, a transmission station 100 includes a housing 110, a network hub 120 and a power supply 130. The network hub 120 is disposed in the housing 110 and configured to transceive a plurality of transmission signals. Therein, the transmission signals include, for example, network signals, data signals or control signals. The network hub 120 includes N signal-transmitting ports 121-1, 121-2, . . . and 121-N to transceive transmission signals 122-1, 122-2, . . . and 122-N to N network devices 50-1, 50-2, . . . and 50-N.

The power supply 130 is disposed in the housing 110 and configured to receive an input power P-IN and produce an operating power 132 and N output power 131-1, 131-2, . . . and 131-N. The operating power 132 is provided to the network hub 120, and the output power 131-1, 131-2, . . . , 131-N is provided to the N network devices 50-1, 50-2, . . . and 50-N through N power-outputting ports 133-1, 133-2, . . . and 133-N, respectively. In the present embodiment, N is an arbitrary positive integer and represents a number of the signal-transmitting ports and a number of the power-outputting ports of the network hub 120, and the present invention is not intent to limit the value of N.

As illustrated in FIG. 1, after the input power P-IN is provided to the power supply 130, the power supply 130 further produces the output power 131 and the operating power 132 to related elements. The transmission station 100 may obtain the input power P-IN by plugging a power plug into a power socket or from a device, such as a mobile power supply or a battery.

In the present embodiment, the power supply 130 and the network hub 120 are integrated in the transmission station 100. The transmission station 100 provides power and transceiver a plurality of transmission signals to the N network devices 50-1, 50-2, . . . and 50-N. As such, a user may connect a plurality of network devices merely through the transmission station 100. In addition, by integrating the power supply 130 and the network hub 120 in the transmission station 100, an advantage of space saving may be achieved. Accordingly, the transmission station 100 has convenience of usage.

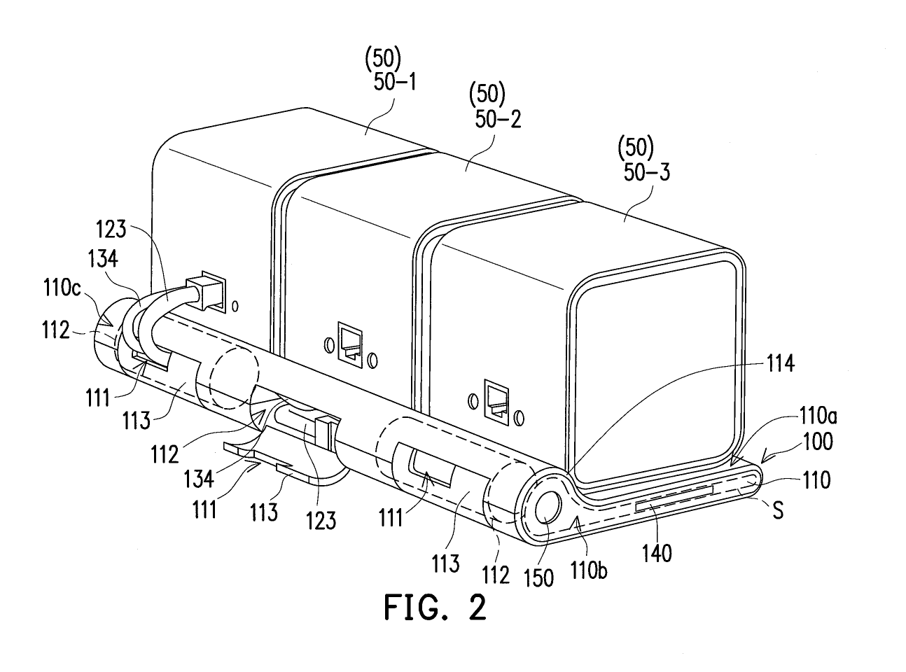

FIG. 2 is a schematic perspective diagram of implementing the transmission station depicted in FIG. 1 according to an embodiment of the present invention. It is to be mentioned here that the transmission station illustrated in FIG. 2 is only one of the implementation manners of the transmission station 100 depicted in FIG. 1, and the transmission station 100 is not limited to the configuration of FIG. 2.

Referring to FIG. 1 with FIG. 2, the transmission station 100 includes the housing 110, the network hub 120 and the power supply 130. The housing 110 surrounds a containing space S and has a supporting surface 110a. The network hub 120 and the power supply 130 are disposed in the containing space S. As illustrated in FIG. 2, for example, the supporting surface of the transmission station 100 carries three network devices 50-1, 50-2 and 50-3 are, and namely, in the present embodiment, N is equal to 3. Thus, the transmission station 100 depicted in FIG. 2 is adapted to provide power to the three network devices 50-1, 50-2 and 50-3 and transmit or receive the transmission signals to or from the network devices 50-1, 50-2 and 50-3. The network hub 120 includes three signal-transmitting ports 121-1, 121-2 and 121-3, and the power supply 130 includes three power-outputting ports 133-1, 133-2 and 133-3. However, the present invention is not intent to limit the number of the network devices to three, and in other embodiments, the transmission station 100 may be connected with one or more network devices.

It is to be mentioned that in the present embodiment, the network devices 50-1, 50-2 and 50-3 are not only connected with the transmission station 100, but also separately disconnected from each other and individually used. Accordingly, the network devices 50-1, 50-2 and 50-3 have good usage flexibility.

Moreover, the network devices 50-1, 50-2 and 50-3 of the present embodiment may be the same type or different types of network devices, such as a wireless access point (AP), a femtocell access point and an ADSL router. The network device 50 disposed on the transmission station 100 of the present invention is not limited to the aforementioned types.

Additionally, the transmission station 100 depicted in FIG. 2 further includes a power input port 150 and the input power P-IN may be connected to the power supply 130 through the power input port 150. In the present embodiment, the power input port 150 is disposed on a first side 110b of the transmission station 100 and for example, a power plug for being plugged into a power socket to obtain the input power P-IN. Otherwise, the power input port 150 may be any other type of connector plug used to plug into a mobile power device to obtain the input power P-IN.

Referring to FIG. 1 with FIG. 2, the power supply 130 of the present embodiment further produces an expanded output power 135, and the network hub 120 further transceives an expanded transmission signal 124. In the present embodiment, the transmission station 100 may be connected with another transmission station and transmit the expanded output power 135 and the expanded transmission signal 124 to another transmission station. In detail, the transmission station 100 of the present embodiment further includes a circuit board and a expansion connector 140. The circuit board is disposed in the containing space S. The network hub 120 and the power supply 130 are disposed on the circuit board. The expansion connector 140 is disposed on the first side 110b of the housing 110 and coupled with the circuit board. In the present embodiment, the expansion connector 140 receives the expanded output power 135 provided by the power supply 130 and the expanded transmission signal 124 provided by the network hub 120.

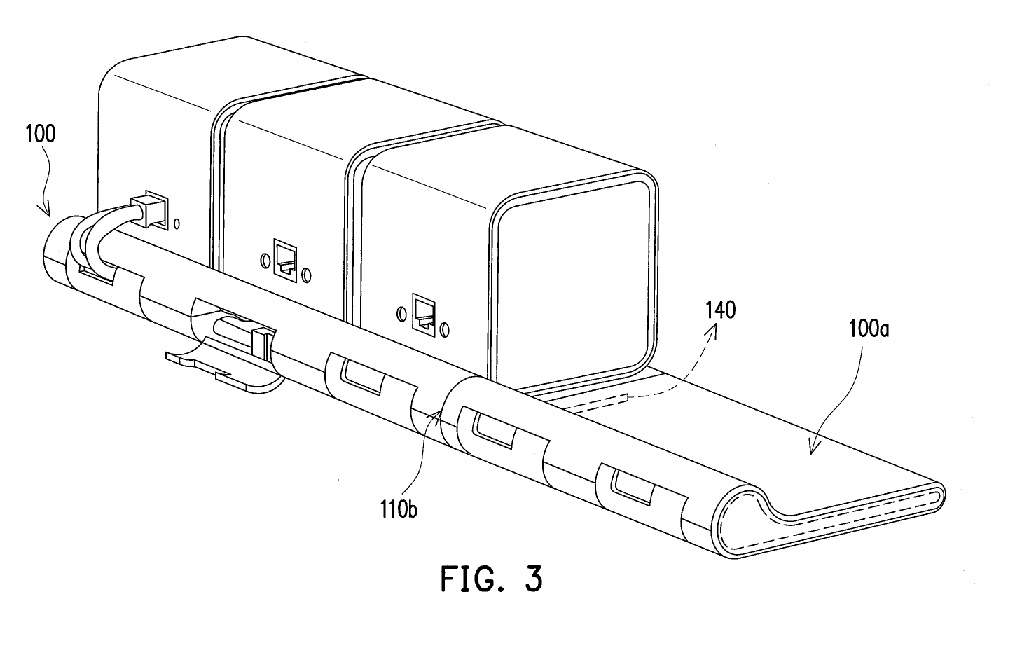

FIG. 3 is a schematic perspective diagram illustrating the transmission station depicted in FIG. 2 connected with another transmission station. Referring to FIG. 3, the transmission station 100 may be connected with another transmission station 100a through the expansion connector 140 on the first side 110b. The transmission station 100a may be a transmission station having the same specification as the transmission station 100 and includes a circuit board and an expansion connector slot (not shown) disposed on the circuit board. When the transmission station 100 is connected with the transmission station 100a, the expansion connector 140 is electrically connected to the expansion connector slot of the transmission station 100a, such that the two transmission stations are connected with each other. The transmission station 100a may be further connected with still another transmission station. Accordingly, the transmission station 100 of the present embodiment not only integrates the power supply 130 and the network hub 120 but also has an expansion capability. It is to be mentioned that the housing 110 of the transmission station 100 may further include a fastening structure, such as a latch. When the transmission station 100 is connected with another transmission station 100a, the fastening structure is fastened to another transmission station 100a, such that the two transmission stations are assembled with each other stably.

Referring to FIG. 2, the housing 110 includes a plurality of connection openings 111 located on a second side 110c of the housing 110, and the signal-transmitting ports 121 and the power-outputting ports 133 are respectively exposed from the connection openings 111. As illustrated in FIG. 2, the first side 110b and the second side 110c are different sides of the housing 110. In the present embodiment, each of the connection openings 111 exposes one signal-transmitting port 121 and one power-outputting port 133 to provide power and transceive signals to one of the network devices 50.

To be more specific, the network hub 120 includes a plurality of network lines 123 (which is illustrated as one in FIG. 2). Each of the network lines 123 passes through the corresponding connection opening 111 to connect with the corresponding signal-transmitting port 121 and the corresponding network device 50. The power supply 130 includes a plurality of power lines 134 (which is illustrated as one in FIG. 2). Each of the power lines 134 passes through the corresponding connection opening 111 to connect with the corresponding power-outputting port 133 and the corresponding network device 50. In the present embodiment, one end of each of the power lines 134 is connected with the corresponding power-outputting port 133, and the other end is connected with a power plug or a universal serial bus (USB) connector plug. In other words, the power lines 134 may be connected with different types of connectors, such that the transmission station 100 has good design flexibility. Moreover, one end of the network line 123 is connected with the corresponding signal-transmitting port 121, and the other end is connected with a network connector. Therein the network connector is, for example, a RJ45 connector, and the network line 123 is, a RJ45 network line.

Here, it is to be mentioned that in the present embodiment, each of the network devices 50 is wired connected with the corresponding signal-transmitting port 121 and the corresponding power-outputting ports 133, but the present invention is not limited thereto. For instance, each of the network devices 50 may further include a network connector and a power connector and be plugged into the corresponding signal-transmitting port 121 and the corresponding power-outputting port 133 by using the network connector and the power connector so as to achieve providing power and transceiving signals, likewise.

Referring to FIG. 2, the housing 110 includes a plurality of containing slots 112 disposed on the second side 110c of the housing 110, such that each of the network line 123 and each of the power lines 134 are retracted in the corresponding containing slot 112. Additionally, the housing 110 includes a plurality of side covers 113 pivoted to the housing 110 and covering the corresponding containing slot 112. Each of the connection openings 111 is disposed on the corresponding side cover 113. When not in use, the user may retract the network line 123 and the power lines 134 in one of the containing slots 112 (e.g. the containing slot 112 illustrated in the middle of the FIG. 2). When connecting the network line 123 and the power line 134 to the corresponding network device 50, the user may pull out the network line 123 and the power line 134 from the corresponding connection opening 111 (e.g. the containing slot 112 illustrated at the left of the FIG. 2).

In addition, the housing 110 further includes a supporting portion 114. The supporting portion 114 contacts the supporting surface 110a, and each of the network devices 50 leans against the supporting portion 114 so as to avoid the quality of the transmission signals being influenced due to the network device 50 wobbling when being placed on the supporting surface 110a. In the present embodiment, each of the network devices 50 may be fastened on the transmission station 100 by, for example, being locked so to improve the stable effect of each of the network devices 50 being fastened to the transmission station 100.

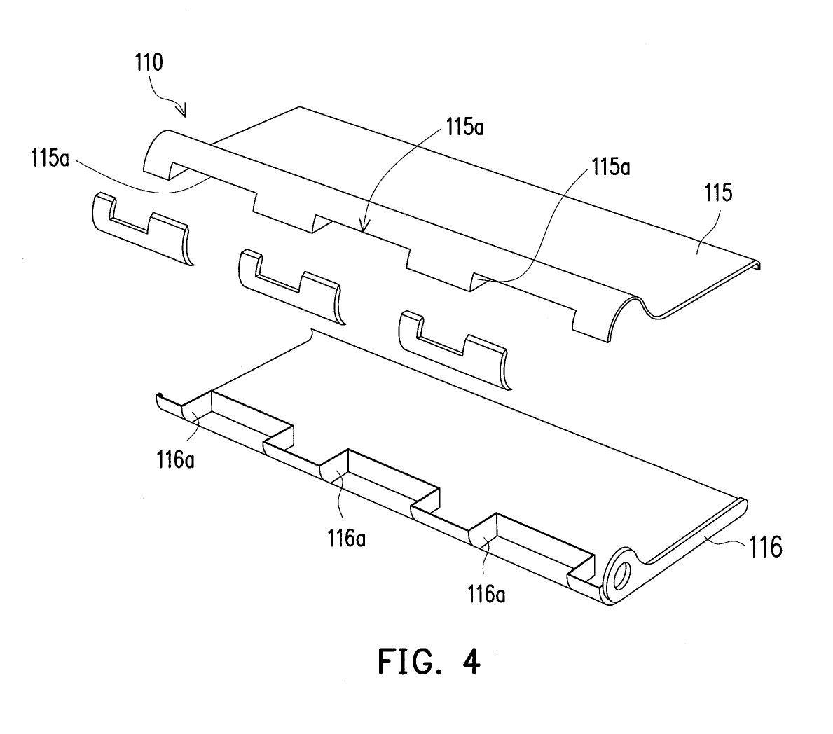

FIG. 4 is an exploded diagram of the transmission station 100 depicted in FIG. 2. Referring to FIG. 4, the housing 110 includes an upper housing 115 and a lower housing 116. The housing 115 includes a plurality of upper partitions 115a, and the lower housing 116 including a plurality of lower partitions 116a. In the present embodiment, the upper housing 115 may be integrally molded with the upper partitions 115a, and the lower housing 116 may be integrally molded with the lower partitions 116a so as to reduce production cost. The lower housing 116 is adapted to be assembled to the housing 115 to form the containing space S illustrated in FIG. 2, and the upper partitions 115a and the lower partitions 116a surround with the containing slots 112 illustrated in FIG. 1 for retracting each of the network lines 123 and each of the power lines 134.

In light of the foregoing, the power supply of the transmission station of the present invention may provide the operating power to the network hub and provide the output power to each of the network devices. Meanwhile, the power supply and the network hub are integrated in the transmission station, such that the user may provide power and transceive signals to the plurality of network devices merely by using the transmission station. In addition, by integrating the power supply and the network hub in the transmission station, an advantage of space saving may be achieved. In addition, the transmission station includes the containing slots for retracting the network line and the power lines so as to solve the problem of line retraction inconvenience. Accordingly, the transmission station has good usage convenience.

Moreover, the transmission station of the present invention further has an expansion capability, and the expanded output power provided by the power supply and the expanded transmission signal provided by the network hub may be transmitted to another transmission station through the expansion connector. Thus, the transmission station of the present invention further has good usage flexibility.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A transmission station, adapted to provide power to at least one network device and transmit signals to the at least one network device, the transmission station comprising:
a housing, disposed with a containing space and having a supporting surface, wherein the at least one network device is disposed on the supporting surface;
a network hub, disposed in the housing and transceiving a plurality of transmission signals, and comprising:
a plurality of signal-transmitting ports, transceiving the plurality of transmission signals to each of the at least one network device, respectively; and
a power supply, dispose in the housing, producing a plurality of output power and a operating power, providing the operating power to the network hub and comprising:
a plurality of power-outputting ports, providing the plurality of output power to each of the network devices.

2. The transmission station according to claim 1, wherein the power supply further produces an expanded output power, the network hub further transceives an expanded transmission signal, such that the transmission station provides the expanded output power and transmits the expanded transmission signal to another transmission station.

3. The transmission station according to claim 2, wherein the housing further comprises a fastening structure, and the transmission station is adapted to be fastened with another transmission station through the fastening structure.

4. The transmission station according to claim 2, further comprising:
a circuit board, disposed in the containing space, wherein the network hub and the power supply are disposed on the circuit board; and
an expansion connector, disposed on a first side of the housing and coupled with the circuit board, wherein the expansion connector receives the expanded output power provided by the power supply and the expanded transmission signal provided by the network hub.

5. The transmission station according to claim 4, wherein the housing comprises a plurality of connection openings located on a second side of the housing, the plurality of signal-transmitting ports and the plurality of power-outputting ports are exposed from the plurality of connection openings, respectively.

6. The transmission station according to claim 5, wherein the network hub comprises a plurality of network lines, each of the network lines passes through the corresponding connection opening to connect with the corresponding signal-transmitting port and the corresponding network device, the power supply comprises a plurality of power lines, each of the power lines passes through the corresponding connection opening to connect with the corresponding power-outputting port and the corresponding network device.

7. The transmission station according to claim 6, wherein one end of each of the power lines is connected with the corresponding power-outputting port, and the other end of each of the power lines is connected with a power adaptor or a universal serial bus (USB) connector plug.

8. The transmission station according to claim 5, wherein the housing comprises:
a plurality of containing slots, disposed at the second side of the housing, wherein each of the network lines and each of the power lines are retracted in the corresponding containing slot.

9. The transmission station according to claim 8, wherein the housing comprises:
a plurality of side covers, pivoted to the housing and covering the corresponding containing slots, wherein each of the connection openings is disposed on the corresponding side cover.

10. The transmission station according to claim 1, wherein the housing further comprising a supporting portion, the supporting portion contacts the supporting surface and the at least one network device leans against the supporting portion.
